(19) United States
(12) Patent Application Publication
(10) Pub. No.: US 2009/0004318 A1
(43) Pub. Date: Jan. 1, 2009

(54) Induction tunnel coil

(75) Inventors: Bruce F. Taylor, Worthington, OH (US); Robert Kadykowski, New Richmond, OH (US)

Correspondence Address: Roth,Blair,Roberts, Strasfeld & Lodge, 100 Federal Plaza East, Suite 600, YOUNGSTOWN, OH, 44503-1893, US

(73) Assignee: Xaloy, Incorporated

(21) Appl. No.: 12/157,304

(22) Filed: Jun. 9, 2008

Related U.S. Application Data
(60) Provisional application No. 60/937,171, filed on Jun. 26, 2007.

(51) Int. Cl. B28B 21/52; H05B 6/36

(52) U.S. Cl. 425/378.1; 219/675

(57) ABSTRACT

A system for supplying processed material includes a barrel for transporting the processed material, having a chamber and an electrically conductive wall enclosing the chamber. The barrel has a length and an outer surface. Thermal insulation extends along at least a portion of the length and around the outer surface and provides an exterior surface whose contour is uniform and formed without grooves. A coil comprising an electric conductor is encased in an electrical insulating sheath. The coil contacts and encircles the exterior surface in loops forming an induction winding that extends along at least a portion of the length and around the exterior surface in a spiral path. An induction power supply is used for supplying alternating current to the coil at a relatively high frequency.

This application claims priority to and the benefit of U. S. Provisional Application No. 60/937,171, filed Jun. 26, 2007, the full disclosure of which is incorporated herein by reference.

### BACKGROUND OF THE INVENTION

1. Field of the Invention

This invention relates to heating an electrically conductive workpiece by electromagnetic induction. More particularly, the invention relates to induction heating an extrusion or molding barrel using alternating electric current at a high frequency.

2. Description of the Prior Art

It is commonly known how an extruder or molding machine takes fluids or solids, such as plastic or magnesium in such forms as pellets, powder, granules, or chips (hereinafter collectively referred as processed “material”) fed through a feed port in the cylindrical metal tube or barrel, and then mixes, heats, and perhaps melts the processed material into a homogeneous molten state. Of course, there are various means of molding and extruding, such as injection molding, blow molding, injection blow molding, extruding blow molding, sheet extrusion, and profile extrusion, all of which are herein generally referred to as “plastic processing”, and to all of which the present invention may be applied.

Electrical contact resistance heaters are typically used to heat the barrel by means of external circumferential contact. Frequently used types of contact resistance heaters include those commonly referred to in the art as mica band-heaters, ceramic band-heaters, and cast aluminum heaters, which are also referred to generally as cast-in heaters. More rarely barrels are heated by other means, such as by hot oil circulated within channels in the barrel wall or within separate contacting elements through which the oil circulates. Due to the added cost and complexity, and the slower control response of the oil's thermal mass, oil-heated devices are limited to special applications, such as the processing of thermosets, including phenolics, ureas, and rubber.

More recently electromagnetic induction techniques have been applied to heat the barrel with or without contact between the induction windings and the barrel.

Most often, induction cable windings (such as Litz cables), have a round cross-section, wound in a helix to form a tunnel coil, preferably with a thermal insulating layer that is interposed between the cable windings and the heated workpiece. The interposed insulating layer typically includes grooves to set and constrain the pitch of the cable windings, thereby allowing it to function as a winding template, as well as a thermal insulation layer. It has been determined that the pitch of the winding template affects the power distribution along the length of the tunnel coil.

The grooved winding template may be manufactured by various means including vacuum-forming over a die or within a mold. However, forming and/or machining customized grooved winding templates to match the unique dimensional requirements of each application, such as groove pitch and the internal and external diameters of the sleeve, is exceedingly time consuming and costly.

There is a need in the industry for a faster and more efficient way to manufacture and install a thermal insulation layer while optimally setting and constraining the cable winding pitch in a low cost manufacturing operation.

### SUMMARY OF THE INVENTION

A system for supplying processed material includes a barrel for transporting the processed material that includes a chamber and an electrically conductive wall enclosing the chamber and having a length and an outer surface, thermal insulation extending along at least a portion of the length and around the outer surface and providing an exterior surface whose contour is uniform and formed without grooves, a coil comprising an electric conductor encased in an electrical insulating sheath, the coil contacting and encircling the exterior surface in loops forming an induction winding that extends along at least a portion of the length and around the exterior surface in a spiral path, and an electric power source for supplying alternating current to the coil at a relatively high frequency.

The system combines an interposed thermal insulation sleeve that does not require cable winding grooves, with a flat induction cable that is wound around the insulating sleeve to produce a tunnel coil whose pitch is equal to the width of the cable minus any desired cable overlap.

The un-grooved insulation sleeve can be manufactured more quickly and inexpensively than one that requires winding grooves. Alternatively, in lieu of a formed or molded insulating sleeve, the interposed insulating layer can be generated by wrapping a flexible insulating sheet around the workpiece one or more times as needed to produce the requisite overall insulation thickness. The latter approach will allow the use of a less-costly, bulk-manufactured, insulating sheet that can be easily cut to the required length and width for the application. This eliminates the need for more costly and time-consuming vacuum-forming or molding of sleeves that must have application-specific internal and external diameters.

A method for forming an induction winding used to heat processed material, includes providing a barrel formed with a chamber for containing the processed material and an electrically conductive wall enclosing the chamber and having an outer surface and a length that is divided into zones arranged along the length. Thermal insulation is placed along a length of each zone and around the outer surface of the barrel to produce a thermal insulation thickness and an exterior surface whose contour is substantially uniform and formed without grooves. An induction winding is formed in each zone by looping an electric conductor encased in an electrical insulating sheath around the exterior surface, which extends along a length of a zone and around the exterior surface of the thermal insulation in a spiral path. The induction windings of each zone are connected to individual induction power supplies that supply controlled currents to the induction windings at a relatively high frequency. The induction power supplies are in turn connected to a common AC power source.

The method provides a unique, low cost, fast efficient way to manufacture an induction coil and to install a thermal insulation layer while optimally setting and constraining the cable winding pitch.

### DESCRIPTION OF THE DRAWINGS

Having generally described the nature of the invention, reference will now be made to the accompanying drawings used to illustrate and describe the preferred embodiments thereof. Further, these and other advantages will become apparent to those skilled in the art from the following detailed description of the embodiments when considered in the light of these drawings in which:

FIG. 1 is a cross sectional view illustrating a lengthwise segment of an extrusion or molding barrel heated by an induction tunnel coil with thermal insulating layer interposed between the windings of the induction coil and the barrel;

FIG. 2 is a cross sectional end-view of a workpiece, such as a typical molding barrel, surrounded by a thermal insulating sleeve having a single wall thickness;

FIG. 3 is a cross sectional end-view of a workpiece, such as a typical molding barrel, surrounded by a thermal insulating sleeve that includes multiple wraps of a flexible thermal insulating sheet;

FIG. 4 is a top view of a lengthwise segment of a suitable workpiece, such as a typical molding barrel, surrounded by a thermal insulating sleeve and multiple turns of a flat induction winding cable;

FIG. 5 is a cross sectional view of multiple adjacent turns of a flat induction winding cable having a round conductor encased within a rectangular extruded plastic cross-section;

FIG. 6 is a cross sectional view of two flat induction cables of different widths, each having a round conductor encased within a rectangular sheath;

FIG. 7 is a cross sectional view of a flat induction cable having a round conductor encased within a rectangular sheath, whose original manufactured width may later be trimmed to produce cables of different widths;

FIG. 8A is a cross sectional view of a flat induction cable with a round conductor encased within a non-rectangular sheath;

FIG. 8B is a sectional view showing multiple overlapping turns of the cable illustrated in FIG. 8A;

FIG. 9A is a cross sectional view of a flat induction cable with a round conductor encased within an interlocking sheath;

FIG. 9B is a cross sectional view showing multiple interlocking turns of the cable;

FIG. 10A is a cross sectional view of an induction cable having a round conductor encased within a sheath that is affixed to an adhesive tape strip;

FIG. 10B is a cross sectional view showing multiple overlapping turns of the cable illustrated in FIG. 10A;

FIG. 11 is a cross sectional view of a series of flat induction cables of different widths, each having a flat conductor of unique width covered with a sheath;

FIG. 12 is a top view of an induction tunnel coil being applied over the thermal insulation on a workpiece;

FIG. 13 is a top view showing the windings of an induction coil connect to a supply circuit and installed over the thermal insulation on a workpiece; and

FIG. 14 is a side view showing the windings of an induction coil arranged in zones and connected through individual circuits to induction power supplies.

### DESCRIPTION OF THE PREFERRED EMBODIMENT

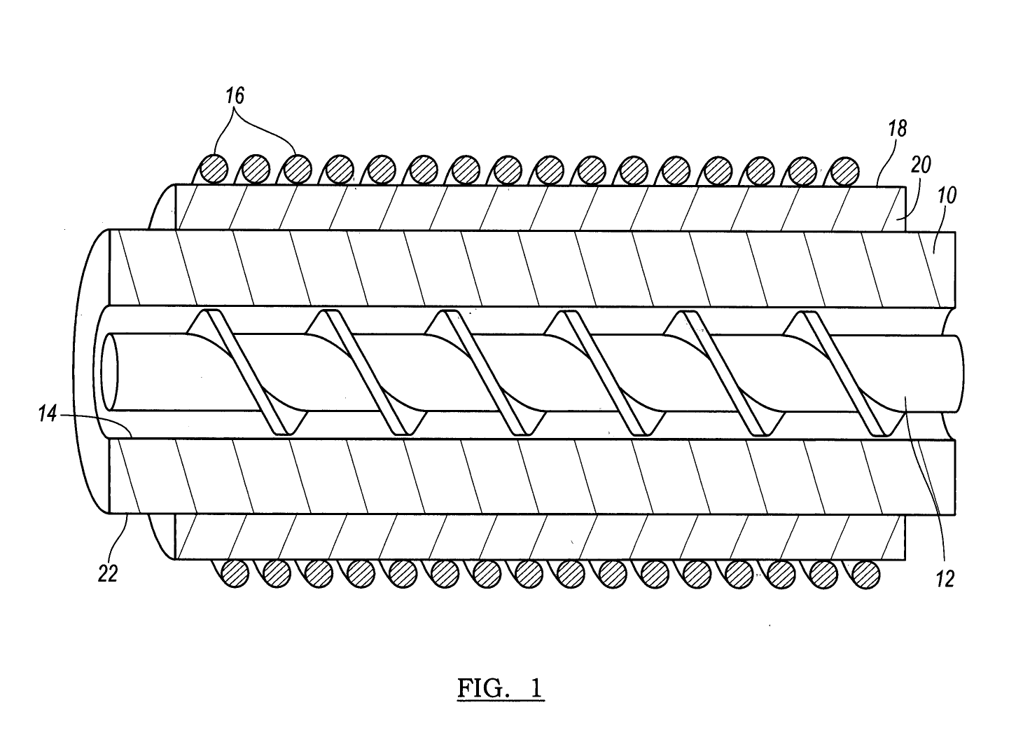

Referring now to the drawings, there is illustrated in FIG. 1 a longitudinal segment of a cylindrical metal extrusion or molding barrel 10 for use with an extruder or molding machine. The barrel 10 contains processed material fed through a feed port in the barrel, and then the material is mixed, heated, and perhaps melted into a homogeneous molten state. Of course, there are various means of molding and extruding, such as injection molding, blow molding, injection blow molding, extrusion blow molding, sheet extrusion, and profile extrusion, all of which are herein generally referred to as “plastics processing”, and to all of which the present invention may be applied as stated previously.

When the barrel 10 is used with extruders and molding machines, a screw 12 rotates within a bore 14 formed in the barrel to ingest the processed material and to transport it along a helical path toward an exit where a nozzle or die is located.

The extrusion or molding barrel 10 is heated by an induction tunnel coil 16, which is wrapped in a helical path around the outer surface 18 of thermal insulation 20, interposed between the windings of the induction coil 16 and the outer surface 22 of the barrel. The tunnel coil 16 is an electrical conductor connected to an induction power supply that supplies alternating current having a frequency in a preferred range of 10-30 kHz.

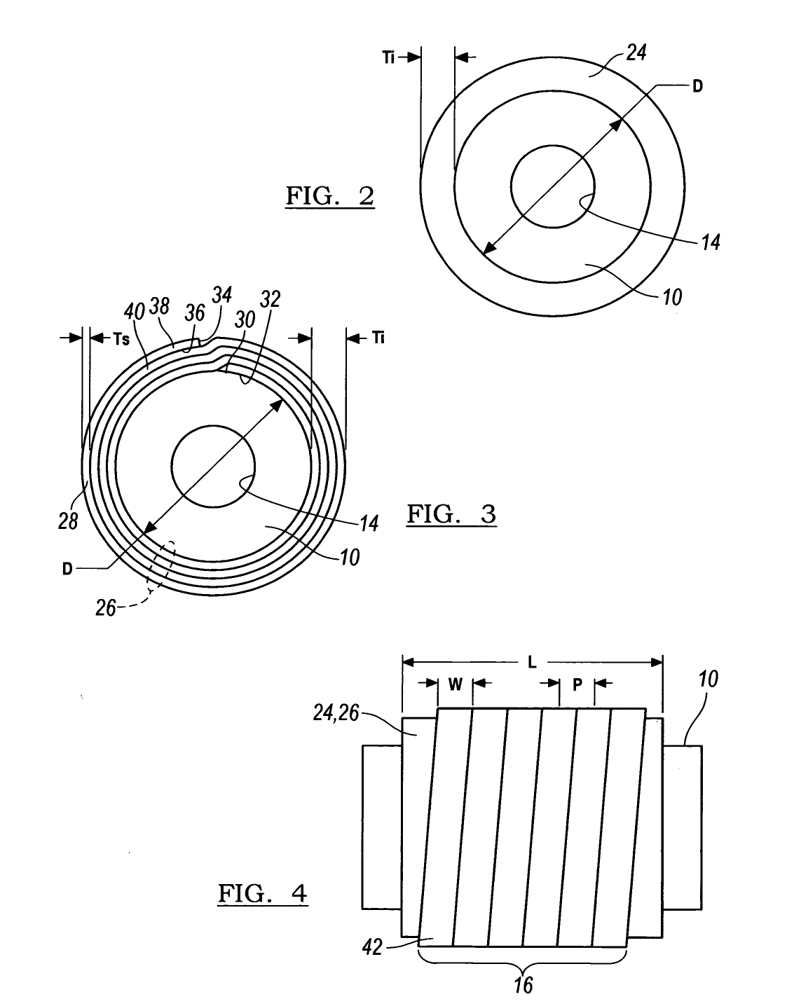

Referring now also to FIG. 2, an embodiment includes thermal insulation in the form of a sleeve 24 having a single thickness “Ti”, surrounding the workpiece or barrel 10, whose outside diameter is “D” and wherein the sleeve 24 does not require winding grooves for containing and guiding the windings of the tunnel coil 16. Due to the absence of winding grooves the sleeve 24 is manufactured more quickly and inexpensively than if it contained grooves.

FIG. 3 illustrates a second embodiment that employs a thermal insulating wrapped sleeve 26 of thickness “Ti” that is formed by wrapping the barrel 10 with multiple layers of a flexible thermal insulating sheet 28 of thickness “Ts”. A commercially available, suitable insulating sheet material is Superwool Paper manufactured by Thermal Ceramics Inc. This adequately flexible and robust sheet material is formed on a specialized papermaking machine and is available in various thicknesses “Ts”, including an approximately 6 mm thick (about ¼ inch) version. Four wraps of this specific material would then result in an overall insulating layer thickness “Ti” of about 24 mm (about 1 inch).

Referring next to FIGS. 3 and 4, the required dimensions of the sheet 28 for any application can be easily calculated assuming no compression of the sheet. For example, if the outer diameter “D” of the workpiece or barrel 10 is 100 mm, the axial length “L” of the barrel 10 that must be covered is 2 meters, the desired sheet thickness “Ts” is 6 mm, and four wraps are preferred to produce an overall insulation thickness “Ti” of 24 mm, in that case the required trimmed dimensions of the sheet 28 is 1.56 meters, i.e. the overall sheet width perpendicular to the axis of the workpiece=π×Σ D+[((2×n)−1)×Ts], for number of wraps=n=1 to 4).

Referring still to FIGS. 1 and 3, the leading edge 30 of the sheet 28 may include an underside adhesive strip 32, thereby allowing the sheet 28 to be affixed to the external surface 22 of the workpiece 10 before wrapping. Similarly, the trailing edge 34 of the sheet 28 may include an underside adhesive strip 36, allowing the last wrap 38 of the sheet 28 to be affixed to the external surface of the second-to-last wrap 40, thereby firmly maintaining the multiple wraps in place after wrapping. The adhesive strips 32, 36 may be formed by the localized application of a double-sided, pressure sensitive adhesive material to the underside of the sheet 28, before or after trimming of the sheet 28 to its required application-specific width and length.

It should be understood that suitable un-grooved insulating sleeves and insulating sheets may be manufactured from a variety of materials by a variety of methods, and that the foregoing embodiments are merely representative.

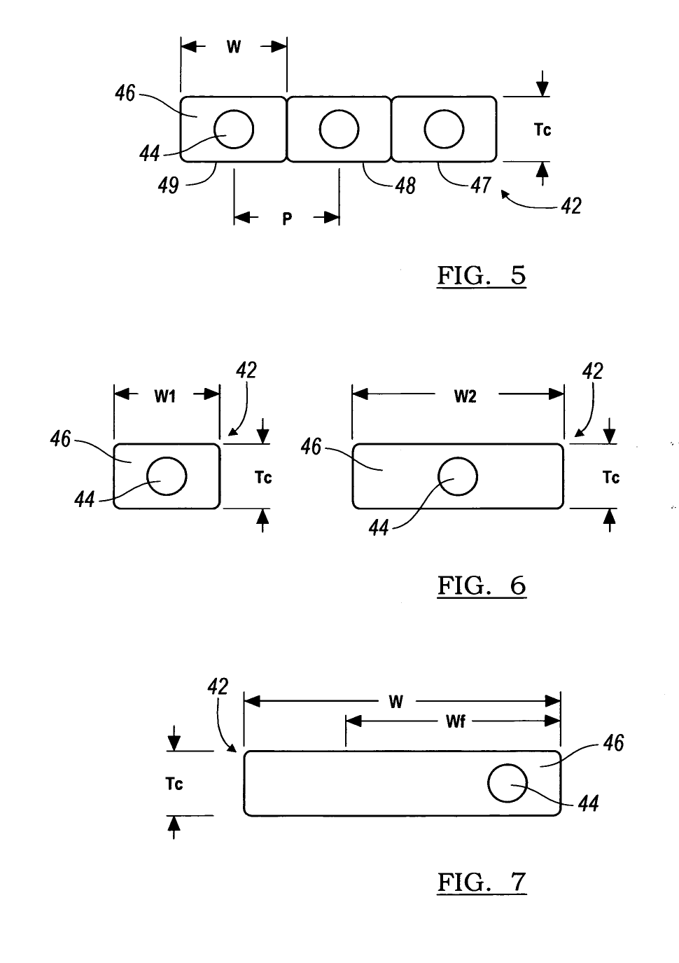

As shown in FIGS. 2 through 4, regardless of the means used to thermally insulate the workpiece 10 with an un-grooved insulating sleeve 24, 28, the use of a flat induction winding cable 42 of width “W” will allow the pitch “P” of the helical tunnel coil 16 to be easily set and maintained. It should be understood that the flat induction winding cable 42 that meets the primary objectives of setting and constraining the winding pitch “P” may have a variety of designed features and cross-sectional shapes, and may be manufactured in a variety of ways from a variety of materials. Accordingly, and referring now to FIGS. 4 and 5, the following flat winding cable 42 embodiments are merely representative.

A preferred embodiment of a flat winding cable 42 consists of a suitable round conductor 44 that includes Litz cable, which comprises many thin wires, individually coated with insulating film and twisted or woven together. The conductor 44 is encased within an extruded rectangular plastic sheath 46, of a suitable material such as Teflon, having a thickness “Tc” that is adequate to protect the conductor 44 and to form a cable 42. Multiple turns 47, 48, 49 of the cable 42 are wrapped contiguously, i.e., without any gap between them, around the workpiece 10. The resulting pitch “P” of the tunnel coil 16 is equal to the width “W” of the cable 42.

Referring next to FIGS. 4 and 6, the cable 42 may also be manufactured in multiple spans or widths (i.e. “W1”, “W2”, etc.) to provide a family of cables that may be used to produce tunnel coils 16 with different pitches (i.e. pitch “P”=“W1” or “W2”, etc.).

Now referring to FIGS. 4 and 7, a single, wider cable 42 may be used, and then its manufactured width “W” may be trimmed to narrower final widths “Wf,” thereby permitting tunnel coils 16 with different pitches “P” to be constructed using a single extruded sheath 46.

In the embodiments of FIGS. 4, 6 and 7, the conductor 44 may also be located symmetrically or asymmetrically within the plastic sheath 46 about either a vertical axis or a horizontal axis or both of these axes.

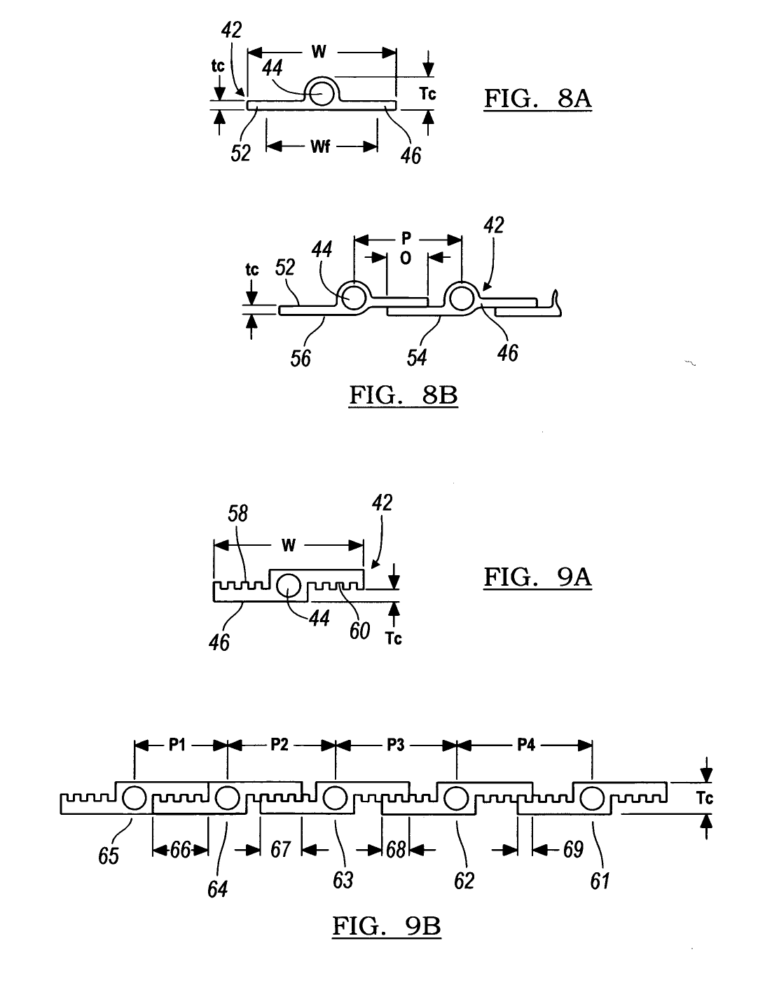

Referring next to FIGS. 4 and 8A, the extruded plastic sheath 46 need not be entirely rectangular, but may be irregularly shaped, so as to reduce the cable's cross-sectional area, making the cable 42 more flexible, decreasing the volume of plastic material, and reducing the cable's cost and weight.

Referring again to FIGS. 4, 8A and 8B, use of thinner arms 52 of thickness “tc” extending laterally from the conductor 44 and sufficiently flexible plastic material allows sequential turns 54, 56 of the coil cable 42 to overlap one another by a specific dimension “O” in order to produce a specific tunnel coil pitch “P”. This may be facilitated by marking or etching the top surface of arm 52 of the plastic sheath 46 with a series of longitudinal overlap dimension lines (not shown) that may be formed into the material during extrusion. While forming the tunnel coil 16 with cable 44 the installer can then use the overlap dimension lines to ensure that the appropriate overlap “O” is used to achieve the appropriate tunnel coil pitch “P” for a given application.

Referring still to FIGS. 4 and 8A, one or another side of the cable's arms 52 may also be trimmed to produce a narrower final width “Wf”; thereby permitting tunnel coils 16 with different pitches “P” to be constructed using a single extruded cable sheath 46.

Referring to FIGS. 4, 9A and 9B, an interlocking extruded plastic sheath 46 may be used to produce a discrete number of optional pitches “P1”, “P2”, “P3”, etc. For example, a cross-section with “N” mating ridges 58 and recesses 60 can be employed to produce “N” discrete pitches “P1” to “PN”, using a single cable cross-section of width “W”. A first arm of sheath 46 has the ridges 58 and recesses 60 directed outward; the second arm has the ridges and recesses directed inward, such that the first arm of one winding engages the second arm of the adjacent winding. Furthermore, although multiple turns 61-65 can be overlapped a constant amount to produce a tunnel coil 16 with a single pitch “P”, different overlaps 66-69 can also be used along the length of the tunnel coil 16 to provide a step-wise variable pitch along the length of the tunnel coil.

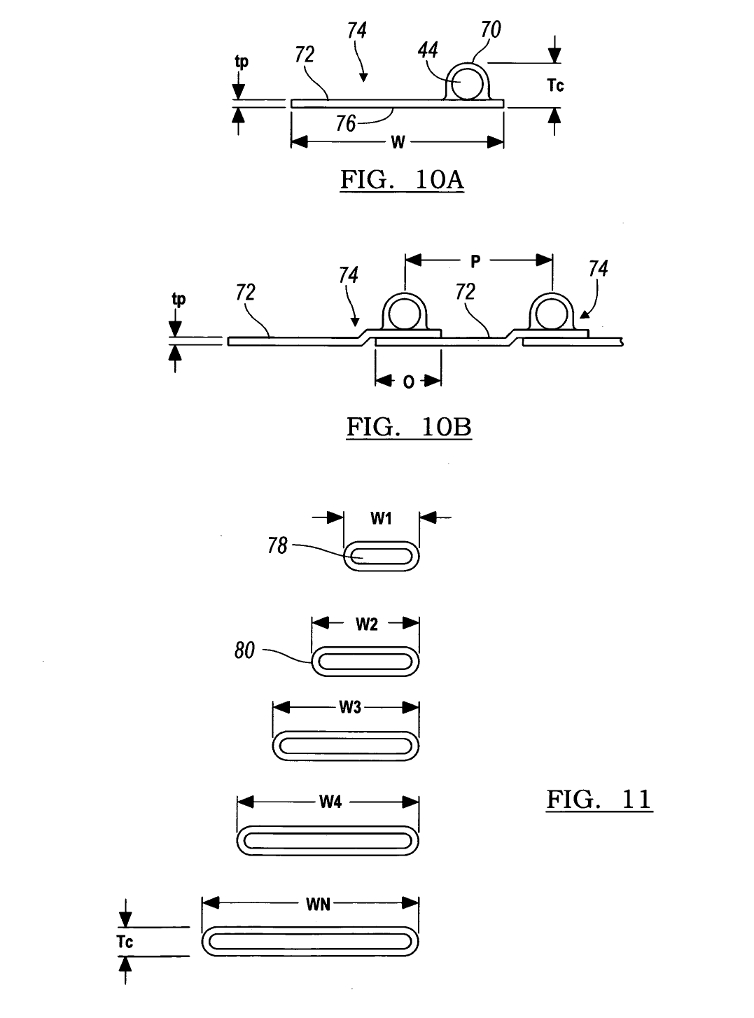

FIGS. 10A and 10B illustrate another embodiment wherein the conductor 44 is encased within a minimal extruded plastic sheath 70, which is also secured during or after extrusion to the top surface of a flat adhesive tape strip 72, thereby forming a flat cable 74 with an adhesive underside 76. Referring also to FIG. 4, the resulting adhesive flat cable 74 may then be affixed to the external surface of the insulation 24, 26.

As illustrated in FIG. 10B, subsequent turns of the adhesive cable 74 may also be overlapped by a specific dimension “O” in order to produce a specific tunnel coil pitch “P”. This may be facilitated by marking or etching the top surfaces of the tape strip 72 with a series of longitudinal overlap dimension lines (not shown) that may be applied to the tape during its manufacture or later during extrusion. Referring also to FIG. 4, while forming the tunnel coil 16 with cable 74, the installer can use the overlap dimension lines to ensure that the appropriate overlap “O” is used to achieve the appropriate tunnel coil pitch “P” for a given application.

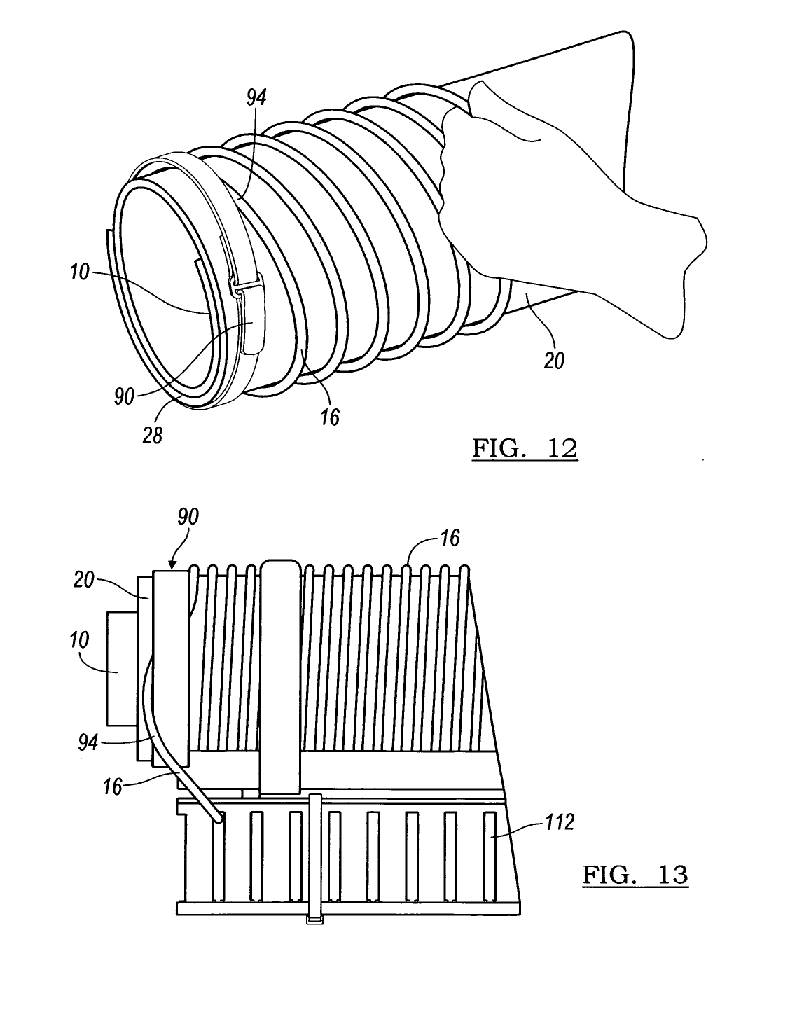

Although all of the foregoing flat cable embodiments include a round conductor 44, it should be understood that the conductor cross-section need not be round. As illustrated in FIG. 11, the conductor 78 may be essentially flat, wherein a family of flat conductors 78 (such as flat braided Litz cables), are covered with a protective extruded plastic coating sheath 80 of suitable material (such as Teflon), so as to form flat cables having mutually different widths.

Referring now to FIGS. 1, 4 and 11, when multiple turns of a flat cable are wrapped contiguously over insulation 20 and around the barrel 10, i.e., without any axial gap between successive coils, the resulting tunnel coil pitch “P” is equal to the specific width (i.e. “W1”, “W2”, “W3”, “W4”, or “W5”) of the flat cable.

A first method for installing the insulation 20 and tunnel coil 16 around the barrel 10 is described with reference to FIGS. 1 and 12. Insulation material 20 in sheet form 28 is wrapped about four times around the outer surface 22 of barrel 10 to a minimum thickness of about 1.0 inch before installing the tunnel coil 16. Preferably, inexpensive, easy to install fastening straps 90 (such as Velcro hook-and-loop straps or buckled Nylon straps) are used to secure the insulation to the barrel at opposite ends of each longitudinal zone along the length of the barrel.

Referring now to FIGS. 1, 5, 12 and 13, a tunnel coil 16, which incorporates a Litz cable conductor 44 enclosed in a sheath 46, is cut to length and adapted for connection to an induction power supply. The tunnel coil 16 is secured to the outer surface of the insulation 20 by placing an end 94 of the coil 16 under the fastening strap 90 at a near end of the respective zone.

The tunnel coil 16 may then be installed over the length of the zone by means of the following procedure: The near end 94 of the cable 16 is slid under the fastening strap 90, which is then retightened to secure the position of the cable end 94; insulation 20 is then rotated with one hand while feeding cable 16 with the other hand, so that the coil pitch is adjusted to the desired dimension; the tunnel coil 16 is wrapped over the full zone length; a second fastening strap, located at the far end of the zone, is then loosened; and the far end of the cable is slid under that strap and retightened. This procedure is repeated for each zone until a desired length of the barrel 10 is coiled.

Referring again to FIGS. 1, 3, 12 and 13, a second method for installing the insulation 20 and tunnel coil 16 around the barrel 10 includes wrapping insulation material 20 in sheet form 28 the desired number of times around the outer surface 22 of the barrel 10 to a minimum thickness of about 1.0 inch; sliding over the end of the barrel a helical pre-coiled tunnel coil 16 that is slightly larger than the outside diameter of the insulation; loosening the fastening strap 90 at the near end of a zone; sliding the coil end 94 under the strap 90; retightening the strap; after spacing the cable to the desired pitch dimension along the zone length, pulling the coil 16 tight against the insulation 20; after applying the coil 16 with the specified number of turns over the full zone length, loosening the fastening strap at the far end of the zone; sliding the far end of the cable under that strap; and retightened the strap. This procedure is repeated for each zone until the desired length of the barrel is coiled.

A third method, described with reference to FIGS. 1, 3 and 13, for installing the insulation 20 and tunnel coil 16 around the barrel 10 includes wrapping insulation material 20 in sheet form 28 the desired number of times around the outer surface 22 of barrel 10 to a minimum thickness of about 1.0 inch; the tunnel coil 16 is pre-coiled such that it is easily held by the person installing it, leaving a tail equal to about half the zone length plus about 6.0 inches; the fastening strap 90 at the near end of a zone is loosened; the coil end 94 is slid under the strap 90 and retightened; the coil 16 is passed from inside to outside as shown in FIG. 13; the coil 16 is hand-wrapped over and around the insulation 20 one turn at a time, spacing the coil turns to the desired pitch dimension; the coil 16 is then pulled tight against the insulation 20; after applying the coil 16 with the specified number of turns over at least a portion of the length of the zone, the fastening strap at the far end of the zone is loosened; and the far end of the cable is slid under that strap and retightened. This procedure is also repeated for each zone until a desired length of the barrel is encircled by the coil 16.

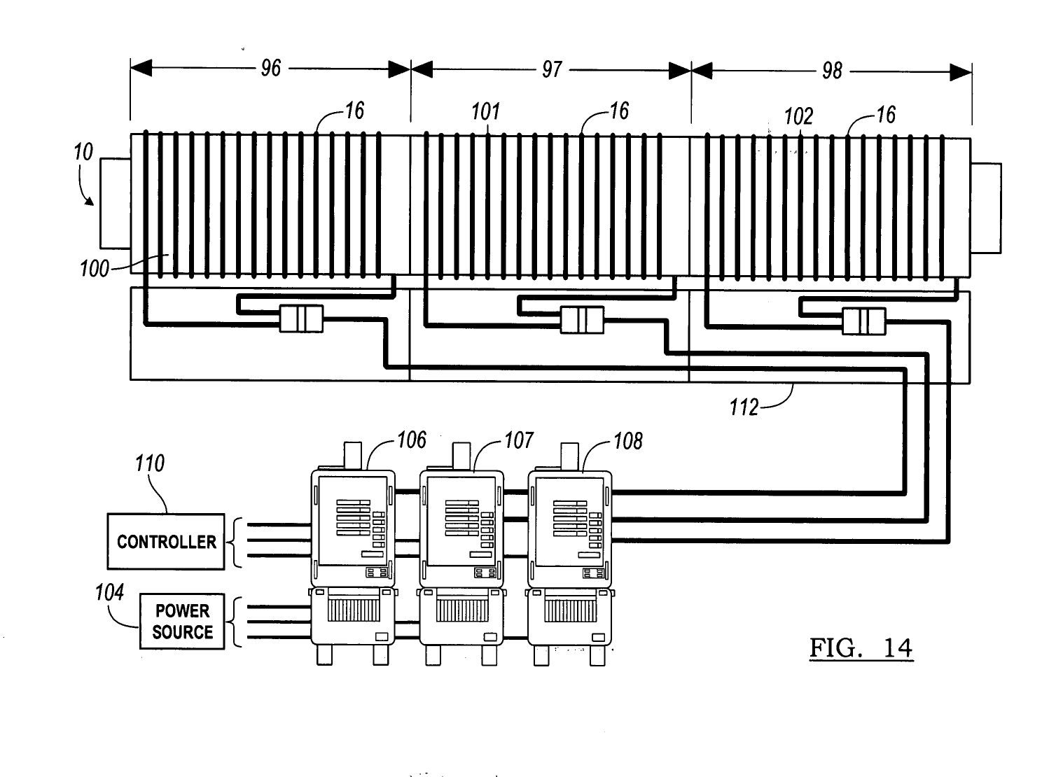

FIG. 14 shows a length of the barrel 10 divided into three longitudinal zones 96-98, each zone being wound with a respective length 100-102 of a tunnel coil 16. An electric power source 104 supplies single or three-phase power at 200-600 VAC and 50-60 Hz to induction power supplies 106-108, each power supply being connected to a respective coil 16 of a zone 96-98. The power supplies 106-108 are each connected electrically to typically 24 VDC on/off control signals originating from PLC-based or PC-based PID temperature controllers 110. Each power supply 106-108 converts the 50-60 Hz power supply voltage to high-frequency power that is supplied to the tunnel coil 16 at preferably about 20 kHz. The output power level can also be preferably adjustable, such as by means of a multi-state dip-switch, e.g., in steps of 2.7, 4.0, 5.3 and 8 kW. The output power is then carried from the induction power supplies 106-108 through a wire-way 112 to the respective tunnel coil 16 of each zone 96-98.

Referring now to FIGS. 1, 5 and 14, the Litz windings conductors 44 form the tunnel coil 16 that produces extremely efficient electromagnetic coupling. Eddy currents produced in the barrel 10 generate powerful resistive heating directly within the barrel wall. The thermal insulation 18 virtually eliminates heat losses from the barrel and keeps the Litz windings conductors 44 cool.

It should be noted that the present invention can be practiced otherwise than as specifically illustrated and described, without departing from its spirit or scope. It is intended that all such modifications and alterations be included insofar as they are consistent with the objectives and spirit of the invention.

What is claimed is:

1. A system for supplying processed material, comprising:
a barrel for transporting the processed material that includes a chamber, a screw supported for rotation in the chamber for advancing the processed material along the barrel, and an electrically conductive wall enclosing the chamber and having a length and an outer surface;
thermal insulation contacting the barrel wall, extending along at least a portion of the length and around the outer surface, and providing an exterior surface whose contour is uniform and formed without grooves;
a coil comprising an electric conductor encased in an electrically insulating sheath, the coil contacting and encircling the exterior surface of the thermal insulation in loops forming an induction winding that extends along at least a portion of the length and around the exterior surface in a spiral path, whose pitch is altered by adjusting a distance between consecutive loops of the winding; and
an induction power supply for supplying alternating current though the coil.

2. The system of claim 1 wherein the conductor is a Litz conductor having a cross section that is one of circular and flat.

3. The system of claim 1 wherein the thermal insulation is one of a sleeve having a uniform thickness that surrounds the outer surface.

4. The system of claim 1 wherein the thermal insulation is a sheet that is wrapped around the outer surface to produce a desired thickness.

5. The system of claim 1 wherein the sheath of the coil has a substantially flat lower surface for positioning over the exterior surface and a width that extends along the length such that the pitch of the coil is altered by adjusting a width of the sheath between the loops of the winding.

6. The system of claim 1 wherein the sheath of the coil includes first and second arms that extend along the length in opposite directions from the conductor, the first arm having a width formed with a series of outwardly directed ridges and recesses and a lower surface for positioning over the exterior surface, the second arm having a width formed with a series of inwardly directed ridges and recesses for engaging the ridges and recesses of the first arm, the first arm of a coil loop overlapping the second arm of a consecutive coil loop winding, and the pitch of the coil being altered by changing the number of ridges and recesses that are mutually engaged.

7. The system of claim 1 wherein the sheath of the coil includes an arm extending away from the conductor and including an inwardly facing adhesive located on a lower surface that extends along the length for positioning over the exterior surface, the sheath of a coil loop overlapping the arm of a consecutive coil loop, the pitch of the coil being altered by changing a dimension of the overlapping.

8. A system for supplying processed material, comprising:
a barrel for transporting the processed material that includes a chamber and an electrically conductive wall enclosing the chamber and having a length and an outer surface;
thermal insulation extending along at least a portion of the length and around the outer surface and providing an exterior surface whose contour is uniform and formed without grooves;
a coil comprising an electric conductor having a circular cross section and encased in a insulating sheath having a circular cross section, the coil contacting and encircling the exterior surface of the thermal insulation in loops forming an induction winding that extends along at least a portion of the length and around the exterior surface in a spiral path, whose pitch is altered by adjusting a distance between consecutive loops of the winding; and
an induction power supply for supplying alternating current through the coil.

9. The system of claim 8 wherein the conductor is a Litz conductor.

10. The system of claim 8 wherein the insulation is a sleeve having a uniform thickness that surrounds the outer surface.

11. The system of claim 8 wherein the insulation is a sheet that is wrapped around the outer surface to produce a desired thickness.

12. A system for supplying processed material, comprising:
a barrel for transporting the processed material that includes a chamber and an electrically conductive wall enclosing the chamber and having a length and an outer surface;
thermal insulation in the form of a sheet that is wrapped successively around the outer surface of the barrel to produce a thickness contacting the barrel wall, extending along at least a portion of the length and around the outer surface, and providing an exterior surface whose contour is substantially uniform and formed without grooves;
a coil comprising an electric conductor encased in an electrical insulating sheath, the coil contacting and encircling the exterior surface of the thermal insulation in loops forming an induction winding that extends along at least a portion of the length and around the exterior surface in a spiral path; and
an induction power supply for supplying alternating current through the coil.

13. The system of claim 12 wherein the conductor is a Litz conductor having a cross section that is one of circular and flat.

14. The system of claim 12 wherein the sheath of the coil has a substantially flat lower surface for positioning over the exterior surface, and a width that extends along the length such that the pitch of the coil is altered by adjusting a width of the sheath between the loops of the winding.

15. The system of claim 12 wherein the sheath of the coil includes first and second arms that extend along the length in opposite directions from the conductor, the first arm having a width formed with a series of outwardly directed ridges and recesses and a lower surface for positioning over the exterior surface, the second arm having a width formed with a series of inwardly directed ridges and recesses for engaging the ridges and recesses of the first arm, the first arm of a winding loop overlapping the second arm of a consecutive winding loop, the pitch of the coil being altered by changing the number of ridges and recesses that are mutually engaged.

16. The system of claim 12 wherein the sheath of the coil includes an arm extending away from the conductor and including an inwardly facing adhesive located on a lower surface that extends along the length for positioning over the exterior surface, the sheath of a coil loop overlapping the arm of a consecutive coil loop, the pitch of the coil being altered by changing a dimension of the overlapping.

17. A method for forming an induction winding used to heat processed material, comprising the steps of:
(a) providing a barrel formed with a chamber for containing the processed material and an electrically conductive wall enclosing the chamber and having a length and an outer surface;
(b) placing thermal insulation along at least a portion of the length and around the outer surface to produce a thickness and an exterior surface whose contour is substantially uniform and formed without grooves;
(c) looping an electric conductor encased in an electrical insulating sheath around the exterior surface of the thermal insulation forming an induction winding that extends along at least a portion of the length and around the exterior surface in loops along a spiral path; and
(d) connecting the winding to an induction power supply that supplies alternating current though the winding.

18. The method of claim 17, wherein step (d) includes the step of connecting the winding to an induction power supply that supplies alternating current though the winding at a relatively high frequency

19. The method of claim 17 wherein step (c) further includes the step of altering the pitch between loops of the winding by adjusting a distance along the barrel between consecutive loops of the winding.

20. The method of claim 17 wherein step (b) further includes the step of wrapping the thermal insulation in the form of a sheet successively around the outer surface to produce a desired thickness.

21. A method for forming an induction winding used to heat processed material, comprising the steps of:
(a) providing a barrel formed with a chamber for containing the processed material and an electrically conductive wall enclosing the chamber and having an outer surface and a length that is divided into zones arranged along the length;
(b) placing thermal insulation along at least a portion of the length of each zone and around the outer surface to produce a thickness and an exterior surface whose contour is substantially uniform and formed without grooves;
(c) forming an induction winding in each zone by looping an electric conductor encased in an electrical insulating sheath around the exterior surface of the thermal insulation, the winding extending along a length of the corresponding zone and around the exterior surface in loops along a spiral path;
(d) interconnecting the induction windings of each zone to individual induction power supplies; and
(e) supplying alternating current from the induction power supplies to the induction windings.

22. The method of claim 21, wherein step (e) includes the step of supplying alternating current from the induction power supply to the induction windings at a relatively high frequency.

23. The method of claim 21 wherein step (c) further includes the step of altering the pitch between loops of the winding by adjusting a distance along the barrel between consecutive loops of the winding.

24. The method of claim 21 wherein step (b) further includes the step of wrapping the insulation in the form of a sheet successively around the outer surface to produce a desired thickness.
